(19) United States
(12) Patent Application Publication
(10) Pub. No.: US 2024/0195715 A1
(43) Pub. Date: Jun. 13, 2024

(54) METHOD AND DEVICE FOR ALLOCATING RADIO RESOURCE

(71) Applicant: MITSUBISHI ELECTRIC CORPORATION, TOKYO (JP)

(72) Inventors: JEAN-CHRISTOPHE SIBEL, RENNES Cedex 7 (FR); NICOLAS GRESSET, RENNES Cedex 7 (FR)

(73) Assignee: MITSUBISHI ELECTRIC CORPORATION, TOKYO (JP)

(21) Appl. No.: 18/286,001

(22) PCT Filed: Oct. 19, 2021
(86) PCT No.: PCT/JP2021/039190

§ 371 Date: Oct. 6, 2023

(30) Foreign Application Priority Data
Apr. 29, 2021 (EP) 21305555.1

(51) Int. Cl. H04L 43/0823; H04W 72/0446; H04W 72/54

(52) U.S. Cl. CPC H04L 43/0823; H04W 72/0446; H04W 72/54

(57) ABSTRACT

A method for allocating a radio resource in a system comprising a resource scheduler and a set of devices is disclosed. Each device hosts at least one application, each application transmitting messages to at least one receiver on a transmission channel. The resource scheduler first receives, from each application, application parameters representative of application's requirements. Then, it computes, for each application, a metric responsive to at least part of the received application parameters, to an average probability of failure of said application and further to a channel error probability of said transmission channel. The metrics are compared and, responsive to said comparison, it selects the application to allocate the radio resource to. The average probability of failure each application is further updated. Finally, it transmits an instantaneous probability of failure to each application, said instantaneous probability of failure being used by said application to update its application parameters.

### TECHNICAL FIELD

At least one of the present embodiments generally relates to a method for allocating, by a resource scheduler, a radio resource in a system comprising a set of devices, each devices hosting at least one application.

### BACKGROUND ART

The Fourth Industrial Revolution (or Industry 4.0) refers to the automation of traditional manufacturing using smart technology such as Internet of Things, cloud computing.

Robotics is part of the Industry 4.0. Indeed, in smart factories, robots are used to limit human operations. In this framework, communications play a key role. The application's requirements in Industry 4.0 is centered on multiple factors such as reliability, latency, longevity of communication devices. Currently, robots are often connected to a wired infrastructure. Time Sensitive Networking (TSN) is the standard Ethernet-based technology for converged networks of Industry 4.0 due to its capacity to support deterministic latency requirements. More precisely, TSN standard extend the traditional Ethernet data-link layer standards to guarantee data transmission with bounded ultra-low latency, low delay variation (jitter), and extremely low loss, which is ideal for industrial control and automotive applications.

TSN defines Time Aware Shaper (TAS) schedulers for guaranteeing the transmission of high priority deterministic traffic in a bounded time. However, TAS suffers from high overhead for short lived flows and thus degrades communication performance.

In addition, contrary to wireless technologies, TSN based networks cannot provide the required flexibility to support mobile industrial applications required for the factories of the future. Wireless networks have many advantages, including flexibility, low cost, ease of deployment but at the cost of reliability.

It is thus desirable to find a method for resource allocation in a wireless environment that satisfies application's requirements while ensuring good communication performance.

### SUMMARY OF INVENTION

At least one of the present embodiments generally relates to a method for allocating a radio resource in a system comprising a resource scheduler and a set of devices, each device hosting at least one application, each application transmitting messages to at least one receiver on a transmission channel. The method comprises, executed by the resource scheduler, at least one iteration n of:
a) receiving, from each application, application parameters representative of application's requirements;
b) computing, for each application, a metric responsive to at least part of the received application parameters, to an average probability of failure of said application and further to a channel error probability of said transmission channel;
c) comparing the metrics and, responsive to said comparison, selecting the application to allocate the radio resource to;
d) updating, for said each application, the average probability of failure; and
e) transmitting an instantaneous probability of failure to each application, said instantaneous probability of failure being used by said application to update at least one of its application parameters.

This method satisfies application's requirements while ensuring good communication performance. Thus, the resource allocation method makes it possible to reduce the number of application failures while still ensuring good communication performance namely thanks to the feedbacks from the resource scheduler to the applications.

In a specific embodiment, a) to e) are repeated iteratively.

In a specific embodiment, said application parameters representative of application's requirements comprise a resilience value, a message lifetime and a message period.

In a specific embodiment, computing, for each application, a metric responsive to at least part of the received application parameters, to an average probability of failure of said application and further to a channel error probability of said transmission channel comprises:
computing, for each application of index k, an instantaneous probability of failure ƒₖ⁽ⁿ⁾ responsive to said at least part of the received application parameters and to said channel error probability Pₑ_{ₖ}⁽ⁿ⁾ of said transmission channel; and
computing said metric Mₖ⁽ⁿ⁾ as follows:

$${M}_{k}^{( n )} = \frac{( 1 - {P}_{{e}_{k}}^{( n )} ) {f}_{k}^{( n )}}{( {N}_{k}^{( n - 1 )} + 1 ) {F}_{k}^{{( n - 1 )}^{α}}}$$

where Nₖ⁽ⁿ⁻¹⁾ is a number of messages buffered by said application of index k since the application started;
Fₖ⁽ⁿ⁻¹⁾ is the average probability of failure of said application of index k at iteration (n−1); and
α is a predetermined parameter.

In a specific embodiment

$${f}_{k}^{( n )} = {P}_{{e}_{k}}^{{( n )}^{{ρ}_{k}^{( n )} H ( {Q}_{k}^{( n )} )}} ,$$

where Qₖ⁽ⁿ⁾ is a number of transmission opportunities before a resilience violation of the application of index k or a number of time slots before a resilience violation of the application of index k, H( ) is a predefined increasing affine function or an identity function and ρₖ⁽ⁿ⁾ is an average resource usage

In a specific embodiment, updating the average probability of failure Fₖ⁽ⁿ⁾ comprises:
computing

$${F}_{{k}^{*}}^{( n )} = \frac{{N}_{{k}^{*}}^{( n - 1 )} {F}_{{k}^{*}}^{( n - 1 )}}{{N}_{{k}^{*}}^{( n - 1 )} + 1} and {N}_{{k}^{*}}^{( n )} = {N}_{{k}^{*}}^{( n - 1 )} + 1 ,$$

in the case where k* is the index of the selected application and a packet corresponding to a message sent by the selected application using the allocated radio resource is received;
otherwise if there is still a transmission opportunity, computing Fₖ⁽ⁿ⁾=Fₖ⁽ⁿ⁻¹⁾ and Nₖ⁽ⁿ⁾ k=Nₖ⁽ⁿ⁻¹⁾ and if there is no more transmission opportunity, computing

$${F}_{k}^{( n )} = \frac{{N}_{k}^{( n - 1 )} {F}_{k}^{( n - 1 )}}{{N}_{k}^{( n - 1 )} + 1} and {N}_{k}^{( n )} = {N}_{k}^{( n - 1 )} + 1.$$

A method for allocating a radio resource in such a system is also disclosed. The method comprises the following steps executed by each device hosting at least one application:
receiving, for said at least one application, an instantaneous probability of failure of said application from said resource scheduler;
updating at least one application parameter representative of application's requirements responsive to said received instantaneous probability of failure and further to a previous value of said application parameter;
transmitting the updated application parameter to said resource scheduler, said updated application parameters being used by said resource scheduler to allocate a new radio resource.

In a specific embodiment, said at least one application parameter being a resilience, updating at least one application parameter comprises comparing the received instantaneous probability of failure with a threshold value and increasing said resilience in the case where the received instantaneous probability of failure is above said threshold value.

In a specific embodiment, updating at least one application parameter comprises updating a resilience and an angular velocity by comparing the received instantaneous probability of failure with a threshold value and decreasing said angular velocity and further increasing said resilience in the case where the received instantaneous probability of failure is above said threshold value.

In a specific embodiment, the method further comprises:
receiving, for said at least one application, an average resource usage of said application from said resource scheduler;
and wherein said at least one application parameter is updated responsive to said received instantaneous probability of failure, to a previous value of said application parameter and further to said average resource usage.

A resource scheduler configured for allocating a radio resource in such a system is further disclosed. The resource scheduler comprises at least one processor configured to:
a) receive, from each application, application parameters representative of application's requirements;
b) compute, for each application, a metric responsive to at least part of the received application parameters, to an average probability of failure of said application and further to a channel error probability of said transmission channel;
c) compare the metrics and, responsive to said comparison, selecting the application to allocate the radio resource to;
d) update, for each application, the average probability of failure; and
e) transmit an instantaneous probability of failure to each application, said instantaneous probability of failure being used by said application to update the application parameters.

A device hosting an application in such a system is disclosed. The device comprises at least one processor configured to:
receive, for said at least one application, an instantaneous probability of failure of said application from said resource scheduler;
update at least one application parameter representative of application's requirements responsive to said received instantaneous probability of failure, and further to a previous value of said application parameter;
transmit the updated application parameter to said resource scheduler, said updated application parameters being used by said resource scheduler to allocate a new radio resource.

A system comprising such a resource scheduler and such a device hosting an application is also disclosed.

A computer program product comprising program code instructions is disclosed that can be loaded in a programmable device, the program code instructions causing implementation of the method according to the various embodiments when the program code instructions are run by the programmable device. A storage medium storing such a computer program is disclosed.

The characteristics of the invention will emerge more clearly from a reading of the following description of at least one example of embodiment, said description being produced with reference to the accompanying drawings.

### BRIEF DESCRIPTION OF DRAWINGS

FIG. 1 depicts a system in which the present embodiments may be implemented.

FIG. 2 illustrates the principle of competition between devices to get a resource allocation.

FIG. 3 illustrates various application parameters that relate to a given application.

FIG. 4 depicts a flowchart of a method for resource allocation according to a specific embodiment.

FIG. 5 illustrates the principle of transmission opportunities for each message of a given stream.

FIG. 6 depicts a flowchart of a method for updating application parameters according to a specific embodiment.

FIG. 7 illustrates the process of updating application parameters according to a specific embodiment.

FIG. 8 illustrates the process of updating application parameters according to another specific embodiment.

FIG. 9 illustrates the process of updating application parameters according to a specific embodiment.

FIG. 10 illustrates the process of updating application parameters according to a specific embodiment.

FIG. 11 illustrates schematically an example of hardware architecture of a resource scheduler according to a specific embodiment.

FIG. 12 illustrates schematically an example of hardware architecture of a device hosting an application according to a specific embodiment.

### DESCRIPTION OF EMBODIMENTS

The various embodiments are disclosed in the context of a smart factory where moving robots are installed to fulfill various missions such as for example moving from one location to another location in the factory within a certain amount of time. However, these embodiments may also apply in other environments such as for example environments including autonomous vehicles.

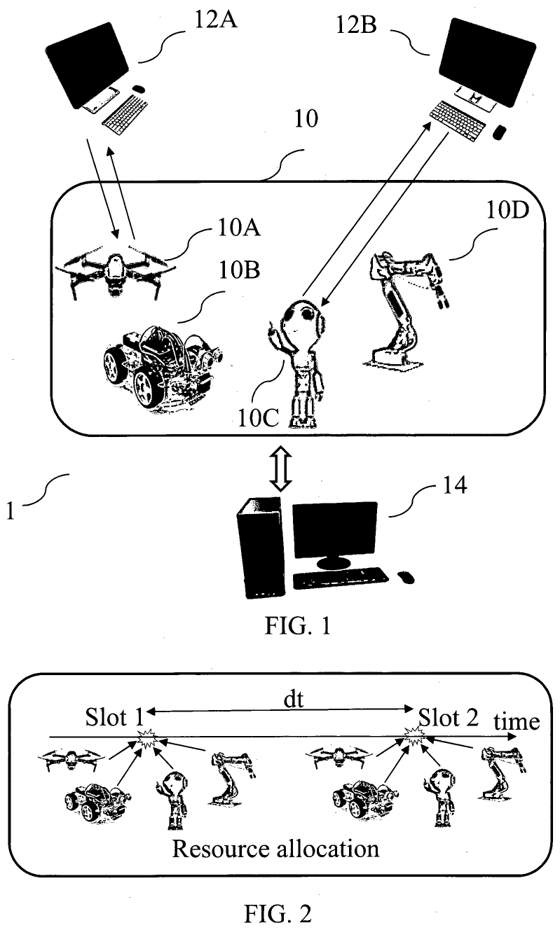

FIG. 1 depicts a system 1, for example as part of a smart factory, in which the present embodiments may be implemented. The system 1 comprises a set 10 of moving robots 10A to 10D, each being capable of moving from one location to another in the factory. The set 10 may also include non-moving robots. The moving robots 10A to 10D are in wireless communication with one or more controlling devices 12A-12B with which they exchange application messages. Each controlling device 12A-12B may be a base station, a MEC (English acronym of “Multi-access Edge Computing”) station or a mobile station. The controlling devices 12A-12B are for example configured to plan and monitor the missions of the robots 10A-10D. As an example, on FIG. 1, the controlling device 12A transmits application messages comprising data representative of its mission to the robot 10A while the controlling device 12B transmits application messages comprising data representative of its mission to the robot 10C. The mission data may comprise displacement data (e.g. angular speed, linear speed, pressure level, etc), interaction data, motion data, etc. In return, the robot 10A (10C respectively) transmits application messages to the controlling device 12A (12B respectively). The application messages transmitted from the robots to the controlling devices comprise for example monitoring data or environment data. Depending on the applications, the exchanges of application messages may be periodic or aperiodic.

Each robot 10A-10D and each controlling device 12A-12B comprises at least one application module. Thus, an application message is more particularly exchanged between the application module of a robot and the application module of a controlling device. An application module generally comprises a software entity, namely the application, along with hardware elements such as an application buffer.

A robot usually comprises several physical elements, e.g. a wheel, an arm, etc. Thus, a given robot may need to exchange application messages comprising different types of data with a controlling device depending on the concerned physical element. Therefore, in the following, a stream Sₖ is defined as the set of application messages mₖ⁽ⁿ⁾ transmitted from (respectively received by) a given physical element of a given robot in the set 10 of robots. Said otherwise a plurality of streams may be associated with one and the same robot, e.g. one stream associated with the arm of the robot and one stream associated with each wheel of the robot. In the following, K streams {S₁, . . . , S_{K}} are considered wherein each stream Sₖ is associated with a given application APPₖ. There is thus a one-to-one association between an application APPₖ and a stream Sₖ. The application APPₖ pushes messages mₖ⁽ⁿ⁾ one-by-one into an application buffer of size one message, the messages mₖ⁽ⁿ⁾ being transmitted at a time instant n using a radio resource to a corresponding receiver, e.g. to a controlling device.

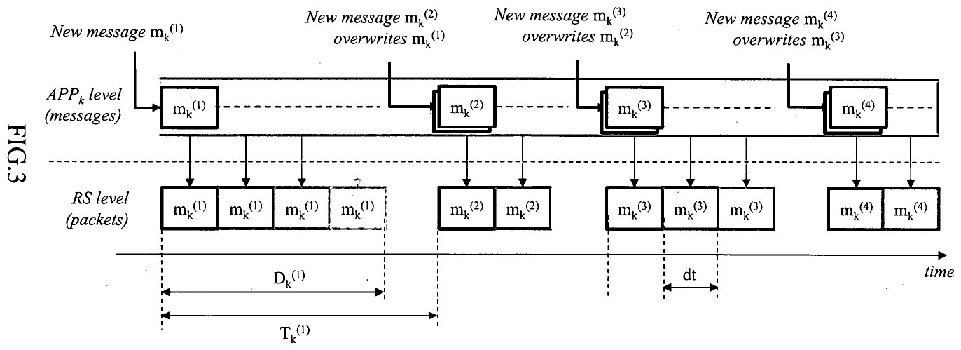

In a wireless environment, the number of radio resources is limited. In the context of radio communication, the number of resources is defined as the number of frequency resources (e.g. subchannels where each subchannel comprises a finite number of frequency blocks) used in a limited amount of time. In order to appropriately allocate these limited radio resources, the system 1 further comprises a resource scheduler (RS) 14 configured to periodically, i.e. every dt (e.g. dt=1 ms), allocate an available radio resource to one specific stream Sₖ. As depicted on FIG. 2, every dt there is thus an opportunity, i.e. a time slot, for an application message mₖ⁽ⁿ⁾ to be sent. As illustrated on FIG. 2 the robots and more precisely the streams are in competition to get the resource allocation. The resource scheduler 14 is thus configured to select one stream among K streams to allocate the radio resource to.

The resource scheduler 14 usually comprises a software entity along with hardware elements such as a buffer. The resource scheduler may be located in a base station, a MEC station or a mobile station.

FIG. 3 illustrates various application parameters that relate to a given application AAPₖ. The application AAPₖ is for example an application, located in one of the controlling device, configured to control the motion of an arm of a specific robot, e.g. the robot 10C. The application AAPₖ may be an application located in a specific robot and configured to monitor the environment of the robot. The application AAPₖ generates several messages mₖ⁽ⁿ⁾ at various time instant n with n=1, 2, 3 and 4. These messages are to be sent on a transmission channel Hₖ between the antenna of a robot, e.g. 10C, associated with the stream Sₖ and the antenna of a controlling device, e.g. 12B. The transmission channel Hₖ is characterized by its channel error probability Pₑ_{ₖ}⁽ⁿ⁾.

Each application AAPₖ has some requirements defined by a set of application parameters whose values may vary temporally, namely a resilience Rₖ⁽ⁿ⁾, a message lifetime Dₖ⁽ⁿ⁾ and a message period Tₖ⁽ⁿ⁾.

The resilience Rₖ⁽ⁿ⁾ is the maximum amount of time the application AAPₖ authorizes for not receiving any message. In case the resilience Rₖ⁽ⁿ⁾ is violated, i.e. the application APPₖ does not receive any message during a time period superior to Rₖ⁽ⁿ⁾, an application failure occurs. In this case, the associated robot may enter in a safety mode, e.g. a partial or complete stop with a reinitialization.

The message lifetime Dₖ⁽ⁿ⁾ is the lifetime of a message my when pushed into the application buffer (also called packet delay budget in the literature). Indeed, the message mₖ⁽ⁿ⁾ of, for example, any monitoring application is only relevant for a limited time duration in particular because of robot motion. On FIG. 3, the lifetime of the first message my mₖ⁽¹⁾ is 4 time slots, the lifetime of the second and fourth messages mₖ⁽²⁾, mₖ⁽⁴⁾ is 2 time slots and the lifetime of the third message mₖ⁽³⁾ is 3 time slots.

The message period Tₖ⁽ⁿ⁾ is the time between the life's start of any two consecutive messages. This period may be variable if the application does not need a periodic traffic.

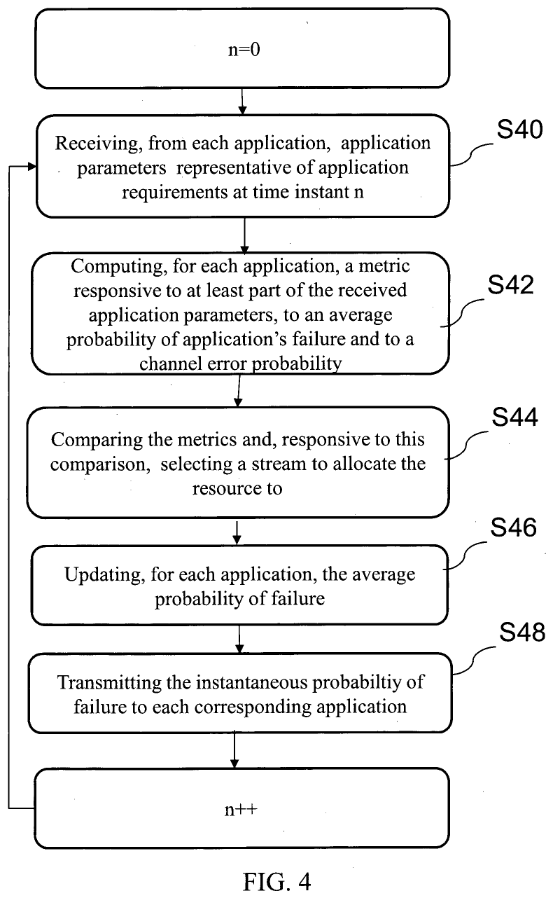

FIG. 4 depicts a flowchart of a method for resource allocation according to a specific embodiment. The method is implemented by the resource scheduler 14.

The resource allocation comprises selecting, for an available radio resource, a single stream Sₖ (thus a single application APPₖ) according to some metrics Mₖ⁽ⁿ⁾. The metrics Mₖ⁽ⁿ⁾ are defined to balance between the satisfaction of the application's requirements of any single stream, e.g. minimizing the number of application failures due to resilience violation, and the sharing of the radio resources between all devices in a most fair manner.

To this aim, the resource scheduler 14 uses for example an α-fair utility-based formalism to ensure a fairness resource allocation between the streams. Accordingly, a local cost function for the k^{th} stream is defined as follows:

$${U}_{α} ( {F}_{k}^{( n )} ) , {U}_{α} ( x ) = \{ \begin{matrix}\frac{{X}^{1 - α}}{1 - α} & α \neq 1 \\ log x & α = 1\end{matrix}$$

where Fₖ⁽ⁿ⁾ is the average probability of failure of the application APPₖ at time instant n. The value of a determines the expected fairness of the resource scheduler 14, e.g. α=1 provides a proportional fair, i.e. a balance between throughput of the network while at the same time allowing at least a minimal level of service for all users and α=10 corresponds to a max-min fairness. A global cost function J⁽ⁿ⁾ is then defined as a function of all the local cost functions. For example, J⁽ⁿ⁾ is defined as the sum over k of the local cost functions:

$${J}^{( n )} = {\sum }_{k = 1}^{N} {U}_{α} ( {F}_{k}^{( n )} ) .$$

The cost function J⁽ⁿ⁾ is thus used by the resource scheduler 14 to select, at time instant n, one stream among the K streams to allocate a radio resource to.

The practical implementation of the resource allocation comprises steps S40 to S46.

At step S40, the resource scheduler 14 receives, from each application APPₖ, the application parameters representative of its application's requirements at time instant n, i.e. Rₖ⁽ⁿ⁾, Dₖ⁽ⁿ⁾, Tₖ⁽ⁿ⁾.

At step S42, the resource scheduler 14 computes, for each stream Sₖ (thus for each application APPₖ), a metric Mₖ⁽ⁿ⁾ responsive to at least part of the received application parameters, i.e. Rₖ⁽ⁿ⁾, Dₖ⁽ⁿ⁾, Tₖ⁽ⁿ⁾, to the average probability of failure Fₖ⁽ⁿ⁻¹⁾ and further to the channel error probability Pₑ_{ₖ}⁽ⁿ⁾. Fₖ⁽ⁿ⁾ is initialized for n=0. For example Fₖ⁽⁰⁾⁼1 or Fₖ⁽⁰⁾ is set to a random value different from zero. Fₖ⁽ⁿ⁾ is updated later on, at step S46.

Each metric Mₖ⁽ⁿ⁾ is computed as follows:

$${M}_{k}^{( n )} = \frac{( 1 - {P}_{{e}_{k}}^{( n )} ) {f}_{k}^{( n )}}{( {N}_{k}^{( n - 1 )} + 1 ) {F}_{k}^{{( n - 1 )}^{α}}} \qquad ( Eq . 1 )$$

where: Nₖ⁽ⁿ⁻¹⁾ is the number of messages buffered by the application APPₖ since the application started;
ƒₖ⁽ⁿ⁾ is an instantaneous probability of failure of APPₖ.

At the time instant n, the probability of failure Fₖ⁽ⁿ⁾ is not known. It is thus predicted from Fₖ⁽ⁿ⁻¹⁾ as follows:

$${\hat{F}}_{k}^{( n )} = \frac{{N}_{k}^{( n - 1 )} {F}_{k}^{( n - 1 )} + ( 1 - {δ}_{k}^{( n )} ( 1 - {P}_{{e}_{k}}^{( n )} ) ) {f}_{k}^{( n )}}{{N}_{k}^{( n - 1 )} + 1} \qquad ( Eq . 2 )$$

where δₖ⁽ⁿ⁾⁼1 in the case the stream k is selected to allocate the radio resource to and δₖ⁽ⁿ⁾⁼0 otherwise.

ƒₖ⁽ⁿ⁾ may be computed in different ways depending on the concern for radio conditions and for application's requirements.

In a first embodiment, the metrics Mₖ⁽ⁿ⁾ take into account the resilience Rₖ⁽ⁿ⁾ in addition to the radio conditions represented by Pₑ_{ₖ}⁽ⁿ⁾ In this embodiment, the function ƒₖ⁽ⁿ⁾ may be defined as follows:

$${f}_{k}^{( n )} = {P}_{{e}_{k}}^{( n )} {e}^{- \frac{{n}_{k} + {R}_{k}^{( n )} - n}{n - 1 - {n}_{k}}}$$

or as follows:

$${f}_{k}^{( n )} = {P}_{{e}_{k}}^{{( n )}^{{Q}_{k}^{( n )}}}$$

where Qₖ⁽ⁿ⁾ is set equal to nₖ+Rₖ⁽ⁿ⁾−n, where nₖ is the last time instant at which a packet for the application APPₖ has been received. The quantity Qₖ⁽ⁿ⁾ represents the number of time slots before a resilience violation, i.e. an application failure. Either Qₖ⁽ⁿ⁾ is decreased by one if the stream does not succeed in transmitting the packet or Qₖ⁽ⁿ⁾ is set to the resilience Rₖ otherwise. Said otherwise, in the case where the packet is correctly transmitted, i.e. if the resource is allocated and the packet is received, then Qₖ⁽ⁿ⁾ is set to the resilience value. In fact, when a transmission succeeded at time instant n, nₖ is set equal to the value n and thus consequently Qₖ⁽ⁿ⁾ is set equal to Rₖ⁽ⁿ⁾.

In the case where the packet is not received (because not allocated or allocated but the transmission is unsuccessful), n is increased by 1 and thus Qₖ⁽ⁿ⁾ is decreased by one.

In a variant of the first embodiment, Qₖ⁽ⁿ⁾ is multiplied by an average resource usage ρₖ⁽ⁿ⁾. As an example, the average resource usage Pₖ⁽ⁿ⁾ is computed by counting the number of resource allocations obtained by the stream Sₖ (or in an equivalent manner by the application APPₖ) until the current time instant n divided by the total number of time slots until the current time instant n. In another example, the average resource usage provides a uniform resource distribution as ρₖ⁽ⁿ⁾⁼1/K where K is the number of streams. In another example, ρₖ⁽ⁿ⁾ reflects the resilience with ρₖ⁽ⁿ⁾⁼1/Rₖ⁽ⁿ⁾. The values of average resource usage thus belong to the interval [0; 1]. In this variant, the function ƒₖ⁽ⁿ⁾ is thus defined as follows:

$${f}_{k}^{( n )} = {P}_{{e}_{k}}^{{( n )}^{{ρ}_{k}^{( n )} {Q}_{k}^{( n )}}}$$

or more generally as follows:

$${f}_{k}^{( n )} = {P}_{{e}_{k}}^{{( n )}^{{ρ}_{k}^{( n )} H ( {Q}_{k}^{( n )} )}} ,$$

where H( ) is a predefined function. As an example, H( ) is the identity function or an increasing affine function of Qₖ⁽ⁿ⁾, e.g. H(Qₖ⁽ⁿ⁾)=Qₖ⁽ⁿ⁾⁻1. In a second embodiment, the message lifetime Dₖ⁽ⁿ⁾ and the message period Tₖ⁽ⁿ⁾ are taken into account in addition to the resilience Rₖ⁽ⁿ⁾ (through N_{T}_{ₖ}⁽ⁿ⁾) and the radio conditions Pₑ_{ₖ}⁽ⁿ⁾. In this embodiment, the function ƒₖ⁽ⁿ⁾ may be defined as follows:

$${f}_{k}^{( n )} = {P}_{{e}_{k}}^{{( n )}^{( {N}_{{T}_{k}}^{( n )} - 1 ) {D}_{k}^{( n )}}} fct ( {D}_{k}^{( n )} , SNR , … )$$

where N_{T}_{ₖ}⁽ⁿ⁾ is the number of remaining messages in the resilience window to be buffered, i.e. (N_{T}_{ₖ}⁽ⁿ⁾⁻1) is the number of remaining messages after the current message, and fct( ) is a predefined function of Dₖ⁽ⁿ⁾ and/or of SNR and/or additional parameters.

By multiplying (N_{T}_{ₖ}⁽ⁿ⁾⁻1) by the message lifetime Dₖ⁽ⁿ⁾, the number of remaining transmission opportunities is obtained as of the next message. For example, in the case of HARQ (English acronym of «Hybrid Automatic Repeat reQuest»), the function ƒₖ⁽ⁿ⁾ may be embodied in such a way that it contains the instantaneous probability of failure for the next messages as well as for the current message. For the latter one, the channel error probability is made lower and lower as the time index increases such that Pₑ_{ₖ}⁽ⁿ⁾≤ Pₑ_{ₖ}⁽ⁿ⁻¹⁾ because the redundancy allows for an SNR increase. As an example,

$${f}_{k}^{( n )} = {P}_{{e}_{k}}^{{( 1 )}^{( {N}_{{T}_{k}}^{( 1 )} - 1 ) {D}_{k}^{( 1 )}}} {P}_{{e}_{k}}^{{( n )}^{{D}_{k}^{( n )} - n + 1}} .$$

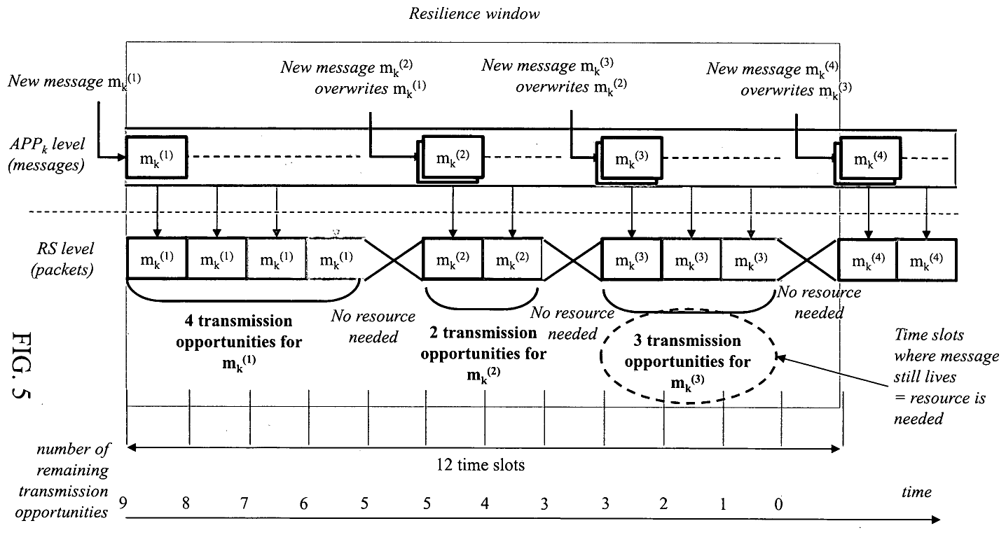

In a variant, the function ƒₖ⁽ⁿ⁾ may be defined as follows:

$${f}_{k}^{( n )} = {P}_{{e}_{k}}^{{( n )}^{{Q}_{k}^{( n )}}}$$

where Qₖ⁽ⁿ⁾ is set equal to max {rₖ+Dₖ⁽ⁿ⁾−n, 0}+(N_{T}_{ₖ}⁽ⁿ⁾⁻1) Dₖ⁽ⁿ⁾ with rₖ being the first time instant wherein the considered message is considered for the scheduling (i.e. it's the life's start of the considered message)). Here, Qₖ⁽ⁿ⁾ represents a number of transmission opportunities before a resilience violation occurs. FIG. 5 illustrates the principle of transmission opportunities for each message of a given stream Sₖ. FIG. 5 is similar to FIG. 3. Therefore, the elements in common are labelled with the same numeral references. On FIG. 5, there are 4 opportunities to transmit the first message, two opportunities for the second message and three opportunities for the third message.

In a variant of the second embodiment, Qₖ⁽ⁿ⁾ is multiplied by an average resource usage ρₖ⁽ⁿ⁾ and ƒₖ⁽ⁿ⁾ is thus defined as follows:

$${f}_{k}^{( n )} = {P}_{{e}_{k}}^{{( n )}^{{ρ}_{k}^{( n )} {Q}_{k}^{( n )}}}$$

or more generally as follows:

$${f}_{k}^{( n )} = {P}_{{e}_{k}}^{{( n )}^{{ρ}_{k}^{( n )} H ( {Q}_{k}^{( n )} )}} ,$$

where H( ) is a predefined function. As an example, H( ) is the identity function or an increasing affine function of Qₖ⁽ⁿ⁾, e.g. H(Qₖ⁽ⁿ⁾)=Qₖ⁽ⁿ⁾⁻1.

In this second embodiment and its variant, Qₖ⁽ⁿ⁾ is thus split into a number of remaining transmission opportunities in the next buffered messages to come and an estimated number dₖ⁽ⁿ⁾ of remaining transmission opportunities in the current message, i.e. before the current message death. When considering that at low layers (PHY, MAC) there might be Hybrid ARQ mechanisms, the instantaneous current packet probability of failure is not only dependent on dₖ⁽ⁿ⁾. Any HARQ-based receiver that accumulates redundancy each time a packet is not well decoded but transmitted (channel failures) observes a reduced current packet probability of failure even considering a constant channel error probability. Indeed, by increasing the redundancy, the probability of well decoding the received packet is increased as if the signal-to-noise ratio (SNR) was greater.

At step S44, the resource scheduler 14 compares the metrics {M₁⁽ⁿ⁾, . . . , M_{K}⁽ⁿ⁾} and, responsive to this comparison, selects a stream k* to allocate the radio resource to. The message m_{k*}⁽ⁿ⁾ of the selected stream is thus sent through the channel H_{k*} to the receiver. At this step, δ_{k*}⁽ⁿ⁾=1 and δₖ⁽ⁿ⁾⁼0 for any k≠k*.

Depending on the definition of the cost J⁽ⁿ⁾:

$${k}^{*} = arg {max}_{k} \{ {M}_{1}^{( n )} , ⋯ , {M}_{K}^{( n )} \} .$$

At step S46, the average probability of failure Fₖ⁽ⁿ⁾ is updated for each k. The updated value Fₖ⁽ⁿ⁾ is to be used for the calculation of the metrics Mₖ⁽ⁿ⁺¹⁾. The probability of failure Fₖ⁽ⁿ⁾ is updated as follows:
For APP_{k*}in the case where the packet corresponding to the sent message is received

$${F}_{{k}^{*}}^{( n )} = \frac{{N}_{{k}^{*}}^{( n - 1 )} {F}_{{k}^{*}}^{( n - 1 )}}{{N}_{{k}^{*}}^{( n - 1 )} + 1}$$

and Nₖ⁽ⁿ⁾ is updated at the same time as follows:

N_{k*}⁽ⁿ⁾=N_{k*}⁽ⁿ⁻¹⁾⁺1
For APP_{k*}in the case where the packet corresponding to the sent message is not received or for any APP_{k≠k*}:
   If there is still a transmission opportunity:

Fₖ⁽ⁿ⁾=Fₖ⁽ⁿ⁻¹⁾ and Nₖ⁽ⁿ⁾=Nₖ⁽ⁿ⁻¹⁾
Otherwise (i.e. there is no more transmission opportunity):

$${F}_{k}^{( n )} = \frac{{N}_{k}^{( n - 1 )} {F}_{k}^{( n - 1 )} + 1}{{N}_{k}^{( n - 1 )} + 1} et {N}_{k}^{( n )} = {N}_{k}^{( n - 1 )} + 1.$$

At step S48, each instantaneous probability of failure ƒₖ⁽ⁿ⁾ computed at S42 is transmitted to the corresponding application APPₖ. The transmitted instantaneous probability of failure ƒₖ⁽ⁿ⁾ is received by the application APPₖ which uses it for updating at least one of its application parameters in order to try to decrease the instantaneous probability of failure at time instant (n+1).

The steps S40 to S48 are repeated iteratively while n is incremented. Thus, n is thus representative of an index of iteration.

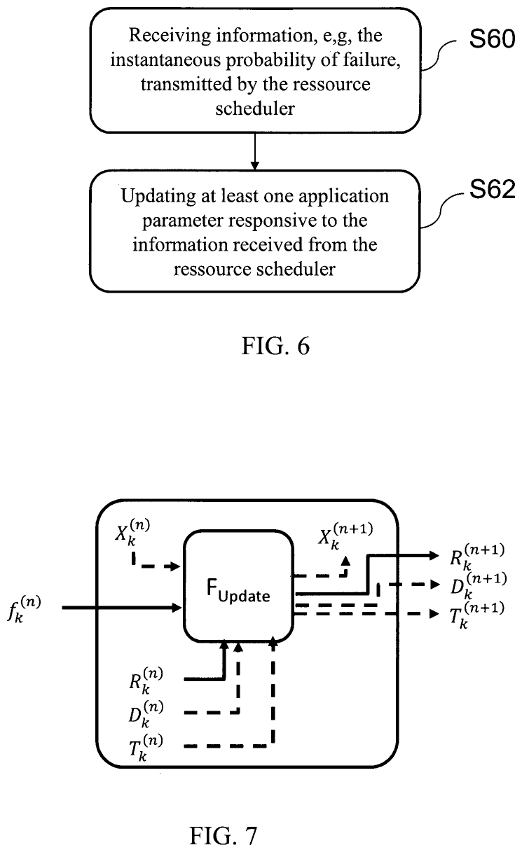

FIG. 6 depicts a flowchart of a method for updating application parameters according to a specific embodiment. The method is implemented in an application module by an application APPₖ.

In a step S60, the application APPₖ receives information, e.g. the instantaneous probability of failure ƒₖ⁽ⁿ⁾ provided by the resource scheduler 14. ƒₖ⁽ⁿ⁾ is only known by the scheduler, i.e. the application is not able to compute it. Consequently, transmitting this information to the application makes it possible for the application to adapt its requirements so as to decrease the probability of failure in the future so that ƒₖ⁽ⁿ⁺¹⁾<ƒₖ⁽ⁿ⁾.

In a step S62, the application APPₖ updates at least one of its application parameters responsive to the received information. As depicted on FIG. 7, the application APPₖ uses as inputs Rₖ⁽ⁿ⁾ and ƒₖ⁽ⁿ⁾ to obtain an updated application parameter Rₖ(n+1). More generally, the application APPₖ uses as inputs ƒₖ⁽ⁿ⁾, Rₖ⁽ⁿ⁾, and optionally Tₖ⁽ⁿ⁾, Dₖ⁽ⁿ⁾, Xₖ⁽ⁿ⁾, to obtain an updated application parameter Rₖ⁽ⁿ⁺¹⁾ and optionally updated application parameters Tₖ⁽ⁿ⁺¹⁾, Dₖ⁽ⁿ⁺¹⁾, Xₖ⁽ⁿ⁺¹⁾. Xₖ⁽ⁿ⁾ is a variable directly related to the application e.g. the velocity of the associated physical element like an arm, a wheel, etc.

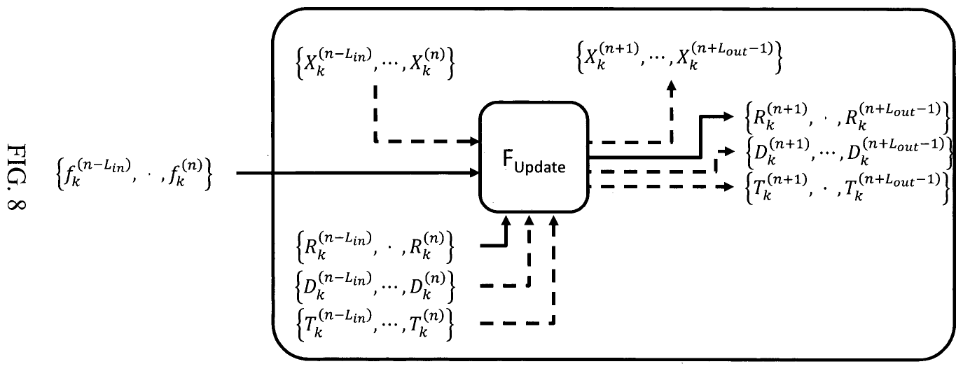

In a variant depicted on FIG. 8, a Lᵢₙ-memory is used. Thus, the application APPₖ receives several instantaneous probabilities of failure ƒₖ^{(t)} provided for time instants tϵ{(n−Lᵢₙ), . . . , (n)}. As an example, Lᵢₙ=0, 1, 2. The application APPₖ uses as inputs {Rₖ^{(n-L}^{ᵢₙ}⁺¹⁾ . . . , Rₖ⁽ⁿ⁾} and {ƒₖ^{(n-L}^{ᵢₙ}⁺¹⁾, . . . , ƒₖ⁽ⁿ⁾} to obtain updated application parameters {Rₖ⁽ⁿ⁺¹⁾, . . . , Rₖ^{(n+L}^{ₒᵤₜ}⁾}. As an example, Lₒᵤₜ=0, 1, 2.

More generally, the application APPₖ uses as inputs {ƒₖ^{(n-L}^{ᵢₙ}⁺¹⁾ . . . , ƒₖ⁽ⁿ⁾}, {Rₖ^{(n-L}^{ᵢₙ}⁺¹⁾, . . . , Rₖ⁽ⁿ⁾}, and optionally {Tₖ^{(n-L}^{ᵢₙ}⁺¹⁾ . . . , Tₖ⁽ⁿ⁾}, {Dₖ^{(n-L}^{ᵢₙ}⁺¹⁾, . . . , Dₖ⁽ⁿ⁾}, {Xₖ^{(n-L}^{ᵢₙ}⁺¹⁾, . . . , xₖ⁽ⁿ⁾}, to obtain updated application parameters {Rₖ⁽ⁿ⁺¹⁾, . . . , Rₖ^{(n+L}^{ₒᵤₜ}⁾} and optionally updated application parameters {Tₖ⁽ⁿ⁺¹⁾, . . . , Tₖ^{(n+L}^{ₒᵤₜ}⁾)}, {Dₖ⁽ⁿ⁺¹⁾, . . . , Dₖ^{(n+L}^{ₒᵤₜ}⁾}, {Xₖ⁽ⁿ⁺¹⁾, . . . , Xₖ^{(n+L}^{ₒᵤₜ}⁾)}.

The updating function F_{update} may be defined in different ways.

In a first embodiment, the application initially considers a maximum probability of failure ƒₖ^{MAX}. The value ƒₖ^{MAX} is determined based on the performance's needs of the application. If the received value ƒₖ⁽ⁿ⁾>ƒₖ^{MAX} then the application allows for a greater resilience such that Rₖ⁽ⁿ⁺¹⁾>Rₖ⁽ⁿ⁾. This way, the stream Sₖ obtains more transmission opportunities. In an example, If the received value ƒₖ⁽ⁿ⁾ is greater than the maximum probability of failure ƒₖ^{MAX}, the resilience is increased by ΔR time slots, i.e. Rₖ⁽ⁿ⁺¹⁾=Rₖ⁽ⁿ⁾+ΔR, e.g. ΔR=1. In this embodiment, only the resilience parameter is updated. Otherwise (i.e. if ƒₖ⁽ⁿ⁾≤ƒₖ^{MAX}), the resilience is not modified. In a variant, the resilience is decreased in the case where ƒₖ⁽ⁿ⁾ is significantly lower than ƒₖ^{MAX}.

In a second embodiment, probabilities of failure {ƒₖ⁽ⁿ⁺¹⁾, . . . , ƒₖ^{(n+L}^{ₒᵤₜ}⁻¹⁾} are estimated from {ƒₖ^{(n-L}^{ᵢₙ}⁾, . . . , ƒₖ⁽ⁿ⁾} as follows:

$$[ \begin{matrix}{f}_{k}^{( n + 1 )} \\ ⋮ \\ {f}_{k}^{( n + {L}_{out} )}\end{matrix} ] = Γ \cdot fctt ( [ \begin{matrix}{f}_{k}^{( n - {L}_{in} + 1 )} \\ ⋮ \\ {f}_{k}^{( n )}\end{matrix} ] )$$

where Γ is a matrix and fctt(•) is a function that combines its input values. For example, fctt( ) is a function that outputs the average, variance, median or maximum of its input values. In a variant, fctt( ) is the identity function.

In a specific example,

$$[ \begin{matrix}{f}_{k}^{( n + 1 )} \\ ⋮ \\ {f}_{k}^{( n + {L}_{out} )}\end{matrix} ] = \frac{1}{{L}_{in}} [ \begin{matrix}{P}_{{e}_{k}}^{- {L}_{in}} & ⋯ & {P}_{{e}_{k}}^{- 2} & {P}_{{e}_{k}}^{- 1} \\ {P}_{{e}_{k}}^{- {L}_{in} - 1} & ⋯ & {P}_{{e}_{k}}^{- 3} & {P}_{{e}_{k}}^{- 2} \\ ⋮ & & ⋮ & ⋮ \\ {P}_{{e}_{k}}^{- {L}_{in} - {L}_{out} + 1} & ⋯ & {P}_{{e}_{k}}^{- {L}_{out} - 1} & {P}_{{e}_{k}}^{- {L}_{out}}\end{matrix} ] [ \begin{matrix}{f}_{k}^{( n - {L}_{in} + 1 )} \\ ⋮ \\ {f}_{k}^{( n )}\end{matrix} ]$$

Given some precomputed relationships between the probability of failure and the application's requirements, the application APPₖ may updates its application parameters {Rₖ⁽ⁿ⁺¹⁾, . . . , Rₖ^{(n+L}^{ₒᵤₜ}⁾}, {Dₖ⁽ⁿ⁺¹⁾, . . . , Dₖ^{(n+L}^{ₒᵤₜ}⁾}, {Tₖ⁽ⁿ⁺¹⁾, . . . , Tₖ^{(n+L}^{ₒᵤₜ}⁾} and {Xₖ⁽ⁿ⁺¹⁾, . . . , Xₖ^{(n+L}^{ₒᵤₜ}⁾} or at least one of them, e.g. the resilience, to ensure that the estimated probabilities of failure {ƒₖ⁽ⁿ⁺¹⁾, . . . , ƒₖ^{(n+L}^{ₒᵤₜ}⁾} are lower than the previous ones, i.e. than {ƒₖ^{(n-L}^{ᵢₙ}⁺¹⁾ . . . ƒₖ⁽ⁿ⁾}. Supposing Pₑ_{ₖ}⁽ⁿ⁾ is constant over time, the application APPₖ can estimate Pₑ_{ₖ} from the formula log ƒₖ⁽ⁿ⁾=Qₖ⁽ⁿ⁾ log Pₑ_{ₖ}. Since Qₖ⁽ⁿ⁾ directly depends on the application's parameters, APPₖ can choose new application parameters therefrom to change the value of the ƒₖ^{(n+j)}, j≥1.

In a third embodiment, the application APPₖ is a control application for a motor of a wheel of a robot. The variable Xₖ⁽ⁿ⁾ represents an angular speed provided by the motor to the wheel at time instant n. The application messages are monitoring information periodically required with the period Tₖ⁽ⁿ⁾ which is directly computed from the angular speed, e.g. Tₖ⁽ⁿ⁾. Given a maximum probability of failure ƒₖ^{MAX}, if ƒₖ⁽ⁿ⁾>ƒₖ^{MAX}, then the application reduces the angular velocity such that Xₖ⁽ⁿ⁺¹⁾<xₖ⁽ⁿ⁾. In an example, Xₖ⁽ⁿ⁺¹⁾ decreased by ΔX, i.e. Xₖ⁽⁺¹⁾=Xₖ⁽ⁿ⁾−ΔX, e.g. ΔX=1 m/s or 2 m/s. The value ΔX is determined based on the performance's needs of the application. Consequently, the period of the application messages increases such that Tₖ⁽⁺¹⁾>Tₖ⁽ⁿ⁾. If the application requires the same number of transmission opportunities within a resilience window, then the resilience is increased such that Rₖ⁽ⁿ⁺¹⁾>Rₖ⁽ⁿ⁾. For example, the resilience is increased by ΔR time slots, i.e. Rₖ⁽ⁿ⁺¹⁾=Rₖ⁽ⁿ⁾+ΔR, e.g. ΔR=1.

In this embodiment, Dₖ⁽ⁿ⁾ is not updated.

In a fourth embodiment, one of the controlling devices 12A-12B acts as a global application that manages all the single applications APPₖ. In the case where too many probabilities of failure ƒₖ⁽ⁿ⁾ are above their threshold ƒₖ^{MAX} then the controlling device that acts as a global application asks for a re-planification of the missions. Some streams, thus some applications APPₖ, may be stopped for a while and some others may have their application parameters redefined.

In a fifth embodiment, the application APPₖ knows some mathematical relationships between ƒₖ⁽ⁿ⁾ and one or more of the parameters Rₖ⁽ⁿ⁾ Tₖ⁽ⁿ⁾ Dₖ⁽ⁿ⁾ Xₖ⁽ⁿ⁾. Said otherwise, the application APPₖ knows the following function G( ): ƒₖ⁽ⁿ⁾=G(Rₖ⁽ⁿ⁾, Tₖ⁽ⁿ⁾, Dₖ⁽ⁿ⁾, Xₖ⁽ⁿ⁾). In another embodiment, only one application parameter or a subset of them is considered as an input of the function G( ) e.g. ƒₖ⁽ⁿ⁾=G(Rₖ⁽ⁿ⁾ Tₖ⁽ⁿ⁾). In this case, the other application parameters are not updated.

The application APPₖ thus computes at least one new application parameter among Rₖ⁽ⁿ⁺¹⁾, Tₖ⁽ⁿ⁺¹⁾, Dₖ⁽ⁿ⁺¹⁾ and optionally Xₖ⁽ⁿ⁺¹⁾ from ƒₖ⁽ⁿ⁺¹⁾ by inverting G( ), ƒₖ⁽ⁿ⁺¹⁾ is determined by the application APPₖ so that it is lower than the received ƒₖ⁽ⁿ⁾ For example, ƒₖ⁽ⁿ⁺¹⁾ is determined as follows: ƒₖ⁽ⁿ⁺¹⁾=ƒₖ⁽ⁿ⁾−Δƒ, e.g. Δƒ=10%. The value Δƒ is determined based on the performance's needs of the application.

In one specific embodiment, the application APPₖ learns the function G( ) offline. In a variant, the application scans all the possible values of all the application parameters and selects the set of values that either minimizes ƒₖ⁽ⁿ⁾ or leads ƒₖ⁽ⁿ⁾ close to an arbitrary target value of ƒₖ⁽ⁿ⁾.

In a sixth embodiment, the application APPₖ transmits to the resource scheduler the target failure probability ƒₖ^{MAX}. In this embodiment, the resource scheduler, instead of the application APPₖ, updates at least one application parameter to ensure a probability of failure ƒₖ⁽ⁿ⁺¹⁾ lower than or equal to ƒₖ^{MAX}.

From ƒₖ^{MAX}, the resource scheduler thus determines values Rₖ⁽ⁿ⁺¹⁾, Tₖ⁽ⁿ⁺¹⁾, Dₖ⁽ⁿ⁺¹⁾ or at least one of them so that ƒₖ⁽ⁿ⁺¹⁾≤ƒₖ^{MAX}. The determined value(s) is(are) transmitted to the corresponding application APPₖ.

In a variant, the resource scheduler only determines a single value of Rₖ⁽ⁿ⁺¹⁾ and transmits it to the corresponding application APPₖ. In this variant, the values Tₖ⁽ⁿ⁺¹⁾ and Dₖ⁽ⁿ⁺¹⁾ are not updated. Thus, they are set equal to the values previously given by the application, i.e. Tₖ⁽ⁿ⁾ Dₖ⁽ⁿ⁾.

In another variant, the resource scheduler determines pairs of values of Rₖ⁽ⁿ⁺¹⁾ Tₖ⁽ⁿ⁺¹⁾ while Dₖ⁽ⁿ⁺¹⁾ is not updated, i.e. Dₖ⁽ⁿ⁾. Since the number of possible pairs might be very high, the resource scheduler may select a finite number of them, for example by taking the values of Rₖ⁽ⁿ⁺¹⁾ in a limited search space, such as a linear quantization between a maximum and minimum value.

In another variant, the application APPₖ informs the resource scheduler of the requested feedbacks, for example, a set of values Tₖ⁽ⁿ⁾, Dₖ⁽ⁿ⁾ satisfying ƒₖ⁽ⁿ⁾=ƒₖ^{MAX} for a fixed value of Rₖ⁽ⁿ⁾ or any combination of this type. In this case, the application APPₖ transmits to the resource scheduler ƒₖ^{MAX} and Rₖ⁽ⁿ⁾. For its part, the resource scheduler determines a set of values Tₖ⁽ⁿ⁺¹⁾ Dₖ⁽ⁿ⁺¹⁾, Dₖ⁽ⁿ⁺¹⁾ satisfying ƒₖ⁽ⁿ⁾=ƒₖ^{MAX} and fulfilling the resilience constraint, i.e. Rₖ⁽ⁿ⁺¹⁾=Rₖ⁽ⁿ⁾.

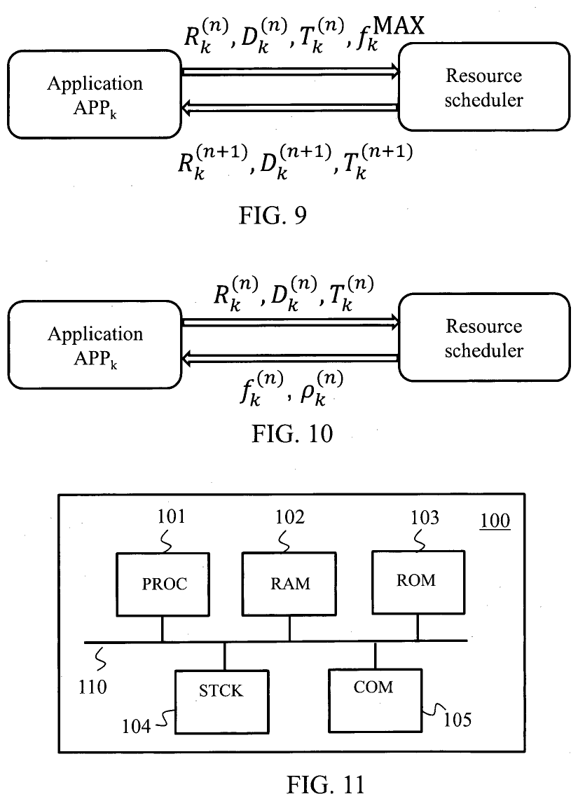

As depicted on FIG. 9, the application parameters updated by the resource scheduler may be either transmitted to the application APPₖ as proposals or directly implemented within the application hardware.

In a seventh embodiment illustrated by FIG. 10, ρₖ⁽ⁿ⁾ is used to compute ƒₖ⁽ⁿ⁾.

ρₖ⁽ⁿ⁾ and ƒₖ⁽ⁿ⁾ are thus transmitted to the application APPₖ which updates at least one of its application parameters in the same manner as mentioned in the first to sixth embodiments, using ρₖ⁽ⁿ⁾ as an additional parameter used to update the application parameter. As an example related to the fourth embodiment, G( ) is defined as (Rₖ⁽ⁿ⁾, Tₖ⁽ⁿ⁾, Dₖ⁽ⁿ⁾, Xₖ⁽ⁿ⁾)=G⁻¹ (ρₖ⁽ⁿ⁾, ƒₖ⁽ⁿ⁾).

FIG. 11 illustrates schematically an example of hardware architecture of a resource scheduler according to a specific embodiment.

The resource scheduler 100 comprises, connected by a communication bus 110: a processor or CPU (acronym of “Central Processing Unit”) 101; a random access memory RAM 102; a read only memory ROM 103; a storage unit 104 such as an hard disk or such as a storage medium reader, e.g. a SD (acronym of “Secure Digital”) card reader; and at least one set of communication interfaces COM 105 enabling the resource scheduler 100 to transmit and receive data.

The processor 101 is capable of executing instructions loaded into the RAM 102 from the ROM 103, from an external memory (such as an SD card), from a storage medium (such as the HDD), or from a communication network. When the resource scheduler 100 is powered up, the processor 101 is capable of reading instructions from the RAM 102 and executing them. These instructions form a computer program causing the implementation, by the processor 101, of the method described in relation to FIG. 4.

The method described in relation to FIG. 4 may be implemented in software form by the execution of the set of instructions by a programmable machine, for example a DSP (acronym of “Digital Signal Processor”), a microcontroller or a GPU (acronym of “Graphics Processing Unit”), or be implemented in hardware form by a machine or a dedicated component (chip or chipset), for example an FPGA (acronym of “Field-Programmable Gate Array”) or an ASIC (acronym of “Application-Specific Integrated Circuit”). In general, the resource scheduler 100 includes electronic circuitry adapted and configured for implementing the method described in relation to FIG. 4.

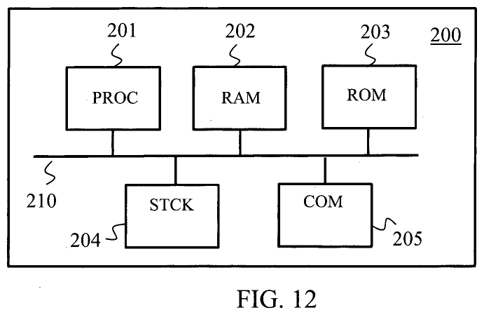

FIG. 12 illustrates schematically an example of hardware architecture of a device 200 hosting an application APPₖ according to a specific embodiment. The device 200 may be a robot or a controlling device.

The device 200 comprises, connected by a communication bus 210: a processor or CPU (acronym of “Central Processing Unit”) 201; a random access memory RAM 202; a read only memory ROM 203; a storage unit 204 such as an hard disk or such as a storage medium reader, e.g. a SD (acronym of “Secure Digital”) card reader; and at least one set of communication interfaces COM 105 enabling the device 200 to transmit and receive data.

The processor 201 is capable of executing instructions loaded into the RAM 202 from the ROM 203, from an external memory (such as an SD card), from a storage medium (such as the HDD), or from a communication network. When the device 200 is powered up, the processor 201 is capable of reading instructions from the RAM 202 and executing them. These instructions form a computer program causing the implementation, by the processor 201, of the method described in relation to FIGS. 6-10.

The method described in relation to FIGS. 6-10 may be implemented in software form by the execution of the set of instructions by a programmable machine, for example a DSP (acronym of “Digital Signal Processor”), a microcontroller or a GPU (acronym of “Graphics Processing Unit”), or be implemented in hardware form by a machine or a dedicated component (chip or chipset), for example an FPGA (acronym of “Field-Programmable Gate Array”) or an ASIC (acronym of “Application-Specific Integrated Circuit”). In general, the device 200 includes electronic circuitry adapted and configured for implementing the method described in relation to FIGS. 6-10.

1. A method for allocating a radio resource in a system comprising a resource scheduler and a set of devices, each device hosting at least one application, each application transmitting messages to at least one receiver on a transmission channel, characterized in that the method comprises, executed by the resource scheduler, at least one iteration n of:
a) receiving, from each application, application parameters representative of application's requirements;
b) computing, for each application, a metric responsive to at least part of the received application parameters, to an average probability of failure of said application and further to a channel error probability of said transmission channel;
c) comparing the metrics and, responsive to said comparison, selecting the application to allocate the radio resource to;
d) updating, for said each application, the average probability of failure; and
e) transmitting an instantaneous probability of failure to each application, said instantaneous probability of failure being used by said application to update at least one of its application parameters.

2. The method according to claim 1, wherein a) to e) are repeated iteratively.

3. The method according to claim 1, wherein said application parameters representative of application's requirements comprise a resilience value, a message lifetime and a message period.

4. The method according to claim 1, wherein computing, for each application, a metric responsive to at least part of the received application parameters, to an average probability of failure of said application and further to a channel error probability of said transmission channel comprises:
computing, for each application of index k, an instantaneous probability of failure ƒₖ⁽ⁿ⁾ responsive to said at least part of the received application parameters and to said channel error probability Pₑ_{ₖ}⁽ⁿ⁾ of said transmission channel; and
computing said metric Mₖ⁽ⁿ⁾ as follows:
$${M}_{k}^{( n )} = \frac{( 1 - {P}_{{e}_{k}}^{( n )} ) {f}_{k}^{( n )}}{( {N}_{k}^{( n - 1 )} + 1 ) {F}_{k}^{{( n - 1 )}^{α}}}$$
where Nₖ⁽ⁿ⁻¹⁾ is a number of messages buffered by said application of index k since the application started;
Fₖ⁽ⁿ⁻¹⁾ is the average probability of failure of said application of index k at iteration (n−1); and α is a predetermined parameter.

5. The method according to claim 4, wherein ƒₖ⁽ⁿ⁾
$${f}_{k}^{( n )} = {P}_{{e}_{k}}^{{( n )}^{{ρ}_{k}^{( n )} H ( {Q}_{k}^{( n )} )}} ,$$
where Qₖ⁽ⁿ⁾ is a number of transmission opportunities before a resilience violation of the application of index k or a number of time slots before a resilience violation of the application of index k, H( ) is a predefined increasing affine function or an identity function and ρₖ⁽ⁿ⁾ is an average resource usage.

6. The method according to claim 1, wherein updating the average probability of failure Fₖ⁽ⁿ⁾ comprises:
computing
$${F}_{{k}^{*}}^{( n )} = \frac{{N}_{{k}^{*}}^{( n - 1 )} {F}_{{k}^{*}}^{( n - 1 )}}{{N}_{{k}^{*}}^{( n - 1 )} + 1}$$
and N_{k*}⁽ⁿ⁾=N_{k*}⁽ⁿ⁻¹⁾⁺1, in the case where k* is the index of the selected application and a packet corresponding to a message sent by the selected application using the allocated radio resource is received;
otherwise if there is still a transmission opportunity, computing Fₖ⁽ⁿ⁾=Fₖ⁽ⁿ⁻¹⁾ and Nₖ⁽ⁿ⁾=Nₖ⁽ⁿ⁻¹⁾ and if there is no more transmission opportunity, computing
$${F}_{k}^{( n )} = \frac{{N}_{k}^{( n - 1 )} {F}_{k}^{( n - 1 )} + 1}{{N}_{k}^{( n - 1 )} + 1}$$
and Nₖ⁽ⁿ⁾=Nₖ⁽ⁿ⁻¹⁾⁺1.

7. A method for allocating a radio resource in a system comprising a resource scheduler and a set of devices, each device hosting at least one application, each application transmitting messages to at least one receiver on a transmission channel, characterized in that the method comprises the following steps executed by each device hosting at least one application:
receiving, for said at least one application, an instantaneous probability of failure of said application from said resource scheduler;
updating at least one application parameter representative of application's requirements responsive to said received instantaneous probability of failure and further to a previous value of said application parameter;
transmitting the updated application parameter to said resource scheduler, said updated application parameters being used by said resource scheduler to allocate a new radio resource.

8. The method according to claim 7, wherein, said at least one application parameter being a resilience, updating at least one application parameter comprises comparing the received instantaneous probability of failure with a threshold value and increasing said resilience in the case where the received instantaneous probability of failure is above said threshold value.

9. The method according to claim 7, wherein updating at least one application parameter comprises updating a resilience and an angular velocity by comparing the received instantaneous probability of failure with a threshold value and decreasing said angular velocity and further increasing said resilience in the case where the received instantaneous probability of failure is above said threshold value.

10. The method according to claim 7, wherein the method further comprises:
receiving, for said at least one application, an average resource usage of said application from said resource scheduler;
and wherein said at least one application parameter is updated responsive to said received instantaneous probability of failure, to a previous value of said application parameter and further to said average resource usage.

11. A resource scheduler configured for allocating a radio resource in a system comprising a set of devices, each device hosting at least one application, each application transmitting messages to at least one receiver on a transmission channel, characterized in that the resource scheduler comprises at least one processor configured to:
a) receive, from each application, application parameters representative of application's requirements;
b) compute, for each application, a metric responsive to at least part of the received application parameters, to an average probability of failure of said application and further to a channel error probability of said transmission channel;
c) compare the metrics and, responsive to said comparison, selecting the application to allocate the radio resource to;
d) update, for each application, the average probability of failure; and
e) transmit an instantaneous probability of failure to each application, said instantaneous probability of failure being used by said application to update the application parameters.

12. A device hosting an application in a system comprising a resource scheduler configured to allocate a radio resource and a set of devices, each device hosting at least one application, each application transmitting messages to at least one receiver on a transmission channel, characterized in that the device comprises at least one processor configured to:
receive, for said at least one application, an instantaneous probability of failure of said application from said resource scheduler;
update at least one application parameter representative of application's requirements responsive to said received instantaneous probability of failure, and further to a previous value of said application parameter;
transmit the updated application parameter to said resource scheduler, said updated application parameters being used by said resource scheduler to allocate a new radio resource.

13. A system comprising a resource scheduler according to claim 11 and a device hosting an application according to claim 12.

14. A computer program product comprising program code instructions that can be loaded in a programmable device, the program code instructions causing implementation of the method according to claim 1 when the program code instructions are run by the programmable device.

15. A storage medium storing a computer program comprising program code instructions, the program code instructions causing implementation of the method according to claim 1 when the program code instructions are read from the storage medium and run by the programmable device.

16. A computer program product comprising program code instructions that can be loaded in a programmable device, the program code instructions causing implementation of the method according to claim 7 when the program code instructions are run by the programmable device.

17. A storage medium storing a computer program comprising program code instructions, the program code instructions causing implementation of the method according to claim 7 when the program code instructions are read from the storage medium and run by the programmable device.
